(19) United States
(12) Patent Application Publication
(10) Pub. No.: US 2020/0096613 A1
(43) Pub. Date: Mar. 26, 2020

(54) LIDAR SYSTEM BASED ON VISIBLE-NEAR INFRARED-SHORTWAVE INFRARED LIGHT BANDS

(71) Applicant: ACADEMY OF OPTO-ELECTRONICS ,CHINESE ACADEMY OF SCIENCES, Beijing (CN)

(72) Inventors: Chuanrong LI, Beijing (CN); Yuwei CHEN, Beijing (CN); Zhen WANG, Beijing (CN); Jian TANG, Beijing (CN); Wei LI, Beijing (CN); Wenjing HE, Beijing (CN); Huijing ZHANG, Beijing (CN); Haohao WU, Beijing (CN); Xiaohui LI, Beijing (CN); Zhaoyan LIU, Beijing (CN)

(21) Appl. No.: 16/305,675

(22) PCT Filed: Jan. 12, 2017
(86) PCT No.: PCT/CN2017/070953

§ 371 Date: Nov. 29, 2018

(30) Foreign Application Priority Data
Jun. 2, 2016 (CN) 201610388371.0

(51) Int. Cl. G01S 7/481

(52) U.S. Cl. CPC G01S 7/4814; G01S 7/4816

(57) ABSTRACT

A lidar system based on visible-near infrared-shortwave infrared light bands comprises a light source sub-system, a light receiving sub-system and a signal collecting and processing sub-system, and adopts a laser light source having a supercontinuum spectrum laser comprising the three bands of visible, near infrared and shortwave infrared light. The lidar system conveniently and effectively achieves hyperspectral measurement of three bands of visible, near-infrared, and shortwave infrared lights without needing to replace the laser light source, increasing the capability of detecting target spectrum information and application range, providing more accurate measurement results and post-processing algorithms, and strengthening the capability of simultaneously detecting visible-near infrared-shortwave infrared ligh bands of a lidar system.

### TECHNICAL FIELD

The present disclosure relates to lidar field, and in particular to a lidar system based on visible-near infrared-shortwave infrared light bands.

### BACKGROUND

A traditional method of using a lidar to measure a target's three-dimensional information and using a spectral imaging device to measure the target's spectral information, requires the lidar and the spectral imaging device to detect and measure the same target at the same time, and then to fusion-match laser ranging data and spectrum imaging data. In terms of hardware, a field of view of the lidar needs to be aligned with a field of view of the spectral imaging device with a high degree of matching. However, an error inevitably occurs in matching alignment, which affects the fusion-matching accuracy of subsequent data. In terms of data processing, based on the high matching alignment of the fields of view of the two sets of devices, it is necessary to correspond a lidar ranging point to a corresponding point on the spectral image data. Since the data points of the lidar ranging are sparse compared with the spectral image data, it is necessary to interpolate the lidar ranging data, increase the number of data points, and correspond with the spectral image data one by one, so as to measure the three-dimensional information and the spectrum of the target at the same time. Interpolation and other operations in data processing procedure will inevitably introduce calculation errors and increase computational complexity, thereby reducing measurement efficiency.

Meanwhile, a typical lidar apparatus may detect single-wavelength laser echo, calculate distance information between a target object point and the lidar system by measuring time of flight of a single-wavelength laser pulse, so as to obtain a three-dimensional model of the target object, and may simultaneously extract a reflectivity of the target object to the current laser band. The disadvantage of the traditional lidar system is that it can only detect and receive laser echo of the emission wavelength, the detection spectral segment being limited by output wavelength of a laser light source and failing to be further broadened in the spectral dimension, and further it cannot detect and receive laser echo of a broader spectrum band from visible light to near infrared to shortwave infrared wave bands. This single-wavelength three-dimensional imaging capability limits the ability of the lidar system detecting various kinds of targets and application range.

Some research institutes use a combination of multiple lasers with different wavelengths as a light source of the lidar to be integrated on the same platform or on the same emission optical path. The disadvantage of this type of lidar is that the output laser is a fixed combination of wavelengths. When the application requirement changes and requires output light of other wavelengths, there is no other available method other than changing the laser light source.

Some research institutes use a tunable laser as a light source of the lidar. The wavelength of the tunable laser can continuously change within a certain spectral segment width range to enable the lidar to measure hyperspectral information of a target object. The disadvantage of this type of lidar is that the tunable laser light source can only output one wavelength of laser at a time. Therefore, in order to perform hyperspectral detection of the target object, the wavelength of the output laser needs to be changed within the tunable spectral range. The change in the wavelength takes time, and thus it is impossible for the hyperspectral lidar to extract multiple spectral information of the target object at the same time.

### SUMMARY

The present disclosure provides a lidar system based on visible-near infrared-shortwave infrared light bands, comprising a light source sub-system, a light receiving sub-system and a signal collecting and processing sub-system; wherein, the light source sub-system generates supercontinuum spectrum laser including visible light, near-infrared light, and shortwave infrared light, part of the supercontinuum spectrum laser is emitted as detection light to a detection target and forms an echo, and part of the supercontinuum spectrum laser is used as a main wave of the lidar and generates a main wave electrical signal; the light receiving sub-system receives an echo reflected from the detection target, divides the echo into a visible-near infrared echo and a shortwave infrared echo, and generates a visible-near infrared echo electrical signal and a shortwave infrared echo electrical signal; and the signal collecting and processing sub-system controls the light source sub-system to emit the supercontinuum spectrum laser, and receives the visible-near infrared echo electrical signal, the shortwave infrared echo electrical signal and the main wave electrical signal, and performs analysis and processing to obtain three-dimensional information and spectral information of the detection target.

Preferably, the light source sub-system includes a laser light source, a beam collimator, a beam splitter, and a main wave photoelectric sensor; wherein the laser light source emits the supercontinuum spectrum laser including the visible light, the near-infrared light, and the shortwave infrared light; the supercontinuum spectrum laser is incident on the beam splitter after being collimated by the beam collimator, part of the light is transmitted through the beam splitter and emitted as the detection light to the detection target, part of the light is reflected by the beam splitter, and the reflected light is received by the main wave photoelectric sensor as a main wave of the lidar, the main wave photoelectric sensor generates the main wave electrical signal.

Preferably, the light receiving sub-system includes a receiving lens, a wavelength splitter, a first diffraction grating, a first photoelectric sensor, a second diffraction grating, and a second photoelectric sensor; wherein: an echo formed after the detection light is reflected by the detection target is received by the receiving lens, and an echo passing through the receiving lens is incident on the wavelength splitter, and the visible-near infrared echo is reflected by the wavelength splitter, the shortwave infrared echo is transmitted through the wavelength splitter; the visible-near infrared echo is incident on the first diffraction grating, the first diffraction grating divides the visible-near infrared echo into optical bands arranged in accordance with wavelengths, the optical bands are incident on the first photoelectric sensor, and the first photoelectric sensor converts the visible-near infrared echo into the visible-near infrared echo electrical signal; and the shortwave infrared echo is incident on the second diffraction grating, the second diffraction grating divides the shortwave infrared echo into optical bands arranged in accordance with wavelengths, the optical bands are incident on the second photoelectric sensor, and the second photoelectric sensor converts the shortwave infrared echo into the shortwave infrared echo electrical signal.

Preferably, the signal collecting and processing sub-system includes a first digital collecting card, a second digital collecting card, and a computer; wherein a signal input end of the first digital collecting card is connected to signal output ends of the main wave photoelectric sensor and the first photoelectric sensor, and a signal input end of the second digital collecting card is connected to signal output ends of the main wave photoelectric sensor and the second photoelectric sensor, the signal output ends of the first digital collecting card and the second digital collecting card are connected to the computer, and a signal output end of the computer is connected to the laser light source.

Preferably, the computer generates a trigger signal that controls the laser light source to emit the supercontinuum spectrum laser; the first digital collecting card and the second digital collecting card receive the main wave electrical signal as a main wave trigger signal, perform digital sampling on the main wave trigger signal, and send the sampled main wave trigger signal to the computer; the first digital collecting card digitally samples the visible-near infrared echo electrical signal and sends the sampled visible-near infrared echo signal to the computer; the second digital collecting card digitally samples the shortwave infrared echo electrical signal and sends the sampled shortwave infrared echo signal to the computer; and the computer performs analysis and processing based on the received sampled main wave trigger signal, the sampled visible-near infrared echo signal and the sampled shortwave infrared echo signal, to obtain the three-dimensional information and the spectral information of the detection target.

Preferably, the light receiving sub-system includes a receiving lens, a wavelength splitter, a first diffraction grating, a first photoelectric sensor, a second diffraction grating, and a second photoelectric sensor; wherein: an echo formed after the detection light is reflected by the detection target is received by the receiving lens, and an echo passing through the receiving lens is incident on the wavelength splitter, and the shortwave infrared echo is reflected by the wavelength splitter, the visible-near infrared echo is transmitted through the wavelength splitter; the shortwave infrared echo is incident on the first diffraction grating, the first diffraction grating divides the shortwave infrared echo into optical bands arranged in accordance with wavelengths, the optical bands are incident on the first photoelectric sensor, and the first photoelectric sensor converts the shortwave infrared echo into the shortwave infrared echo electrical signal; and the visible-near infrared echo is incident on the second diffraction grating, the second diffraction grating divides the visible-near infrared echo into optical bands arranged in accordance with wavelengths, the optical bands are incident on the second photoelectric sensor, and the second photoelectric sensor converts the visible-near infrared echo into the visible-near infrared echo electrical signal.

Preferably, the signal collecting and processing sub-system includes a first digital collecting card, a second digital collecting card, and a computer; wherein a signal input end of the first digital collecting card is connected to signal output ends of the main wave photoelectric sensor and the first photoelectric sensor, and a signal input end of the second digital collecting card is connected to signal output ends of the main wave photoelectric sensor and the second photoelectric sensor, the signal output ends of the first digital collecting card and the second digital collecting card are connected to the computer, and a signal output end of the computer is connected to the laser light source.

Preferably, the computer generates a trigger signal that controls the laser light source to emit the supercontinuum spectrum laser; the first digital collecting card and the second digital collecting card receive the main wave electrical signal as a main wave trigger signal, perform digital sampling on the main wave trigger signal, and send the sampled main wave trigger signal to the computer; the first digital collecting card digitally samples the shortwave infrared echo electrical signal and sends the sampled shortwave infrared echo signal to the computer; the second digital collecting card digitally samples the visible-near infrared echo electrical signal and sends the sampled visible-near infrared echo signal to the computer; and the computer performs analysis and processing based on the received sampled main wave trigger signal, the sampled visible-near infrared echo signal and the sampled shortwave infrared echo signal, to obtain the three-dimensional information and the spectral information of the detection target.

Preferably, the computer is connected to an upper computer, and the computer stores the received sampled main wave trigger signal, the sampled visible-near infrared echo signal and the sampled shortwave infrared echo signal and sends them to the upper computer, and the upper computer performs subsequent analysis and processing to obtain the three-dimensional information and the spectral information of the detection target.

Preferably, the wavelength splitter is a lens with increased transmittance and high reflectivity.

As can be understood from the above solution, the lidar system based on visible-near infrared-shortwave infrared light bands in the present disclosure has the following advantages:

The use of the laser light source emitting supercontinuum spectrum laser including visible light, near-infrared light, and shortwave infrared light enables convenient and efficient hyperspectral measurement of three band of the visible, near-infrared, and shortwave infrared lights without needing to replace the laser light source. The convenient and efficient hyperspectral measurement of the visible light, near-infrared light, and shortwave infrared light to the detection target at the same time can be achieved at the receving end, and the capability of the lidar system detecting spectral information of the target and application range can be improved. The lidar system can also measure the distance of the target, and since the measured target does not have a matching error of an instantaneous field of view, more accurate measurement results and simpler post-processing algorithms can be provided.

### BRIEF DESCRIPTION OF THE DRAWINGS

The accompanying drawings are used to provide a further understanding of the present disclosure and constitute a part of the specification, and are used to explain the present disclosure together with the following specific embodiments, but do not limit the scope of the present disclosure. In the drawings:

FIG. 1 is a structural diagram of a lidar system based on visible-near infrared-shortwave infrared light bands according to a first embodiment of the present disclosure.

### REFERENCE NUMBER DESCRIPTION

11-Laser light source;

12-Beam collimator;

13-Beam splitter;

14-Main wave photoelectric sensor;

21-Receiving lens;

22-Wavelength splitter;

23-First diffraction grating;

24-First photoelectric sensor;

25-Second diffraction grating;

26-Second photoelectric sensor;

31-First digital collecting card;

32-Second digital collecting card;

33-Computer

### DETAILED DESCRIPTION

In order to make the objects, technical solutions, and advantages of the present disclosure more clear, the present disclosure will be described below in further details with reference to specific embodiments in combination with the accompanying drawings.

The solution of the present embodiments will be clearly and fully described below with reference to the accompanying drawings of the embodiments. Apparently, the described embodiments are merely a part, but not all, of the embodiments of the present disclosure. All other embodiments obtained by those skilled in the art based on the embodiments of the present disclosure without creative efforts should fall within the scope of the present disclosure.

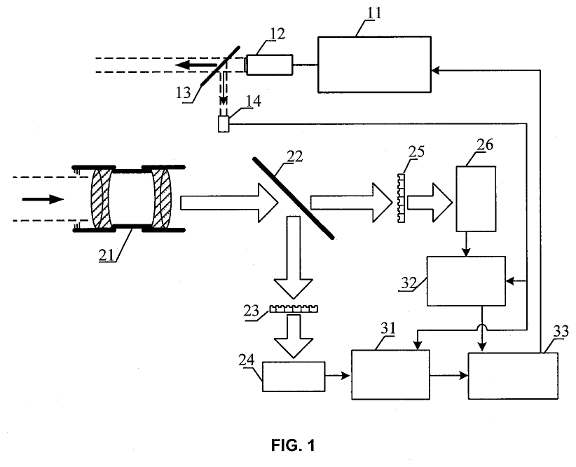

Referring to FIG. 1, a structural diagram of a lidar system based on visible-near infrared-shortwave infrared light bands according to a first embodiment of the present disclosure is illustrated. The lidar system includes a light source sub-system, a light receiving sub-system, and a signal collecting and processing sub-system.

The light source sub-system generates laser which is supercontinuum spectrum laser including three bands of visible light, near-infrared light and shortwave infrared light. A part of the supercontinuum spectrum laser is emitted as detection light to a detection target and forms an echo, and another part of the supercontinuum spectrum laser is used as a main wave of the lidar.

The light receiving sub-system receives an echo reflected by the detection target and divides the echo into a visible-near infrared echo and a shortwave infrared echo.

The signal collecting and processing sub-system receives the visible light-near infrared echo and shortwave infrared echo signals, receives the main wave signal, and performs analysis and processing to obtain three-dimensional information and spectral information of the detection target.

The light source sub-system includes a laser light source 11, a beam collimator 12, a beam splitter 13, and a main wave photoelectric sensor 14. The beam collimator 12 and the beam splitter 13 are sequentially located in front of an optical path of the laser light source. The beam splitter 13 is disposed at an angle of 45 degrees with an optical axis of the laser light source, and the main wave photoelectric sensor 14 is located behind an optical path of a first split optical path of the beam splitter.

The laser light source 11 of the present disclosure may use a variety of supercontinuum spectrum laser sources, such as but not limited to a narrow pulse supercontinuum spectrum laser source with a wavelength range from 400 nm to 2400 nm, an output power of 150 mW or more, a repetition frequency from 25 KHz to 30 KHz, and a pulse width of 1 ns. Preferably, the laser light source 11 is a SCM-30-450 supercontinuum spectrum laser source.

The beam splitter 13 of the present disclosure is a lens with high transmittance and low reflectivity. Most of the laser is transmitted by the lens with high transmittance and low reflectivity, and the rest of the laser is reflected by the lens with high transmittance and low reflectivity. The transmittance may be 99%, and the reflectivity may be 1%; or the transmittance may be 99.9%, and the reflectivity may be 0.1%. The transmittance of the lens with high transmittance and low reflectivity may be higher, and the reflectivity may be lower, as long as the reflected light can be detected by the first photoelectric sensor 14 and an electrical signal can be generated.

The light receiving sub-system includes a receiving lens 21, a wavelength splitter 22, a first diffraction grating 23, a first photoelectric sensor 24, a second diffraction grating 25, and a second photoelectric sensor 26. The wavelength splitter 22 is located behind an optical path of the receiving lens. The wavelength splitter 22 is disposed at an angle of 45 degrees with an optical axis of the receiving lens. The second diffraction grating 25 and the second photoelectric sensor 26 are sequentially located behind an optical path of a first split optical path of the wavelength splitter 22, and the first diffraction grating 23 and the first photoelectric sensor 24 are sequentially located behind an optical path of a second split optical path of the wavelength splitter 22. The wavelength splitter 22 is a lens with increased transmittance and high reflectivity, which has high reflectivity with respect to the laser in visible-near infrared wave bands, and has increased transmittance with respect to the laser in shortwave infrared wave band.

The first photoelectric sensor 24 may be an array of Si detectors, such as but not limited to a PIN or APD detector, and the second photoelectric sensor 26 may be an array of InGaAs detectors.

The signal collecting and processing sub-system includes a first digital collecting card 31, a second digital collecting card 32 and a computer 33. A signal input end of the first digital collecting card is connected to signal output ends of the main wave photoelectric sensor and the first photoelectric sensor, and a signal input end of the second digital collecting card is connected to signal output ends of the main wave photoelectric sensor and the second photoelectric sensor. The signal output ends of the first digital collecting card and the second digital collecting card are connected to the computer 33, and a signal output end of the computer is connected to the laser light source 11.

The bandwidths of the first digital collecting card and the second digital collecting card are greater than or equal to a reciprocal of a width of a laser pulse of the laser light source.

When the lidar system based on visible-near infrared-shortwave infrared light bands of the present disclosure is operating, the computer 33 generates a trigger signal. Under the control of the trigger signal, the laser light source 11 emits supercontinuum spectrum laser including visible light, near-infrared light, and shortwave infrared light. The supercontinuum spectrum laser is collimated by the beam collimator 12 and then is incident on the beam splitter 13. Part of the supercontinuum spectrum laser is transmitted through the beam splitter 13 and emitted as detection light to the detection target. Part of the supercontinuum spectrum laser is reflected by the beam splitter 13, and the reflected light is received as a main wave by the main wave photoelectric sensor 14. The main wave photoelectric sensor 14 generates a main wave trigger signal of the lidar and sends the main wave trigger signal to the first digital collecting card 31 and the second digital collecting card 32. The first digital collecting card 31 and the second digital collecting card 32 digitally sample the main wave trigger signal of the lidar, and send the sampled signal to the computer 33.

An echo formed after the detection light is reflected by the detection target is received by the receiving lens 21. An echo passing through the receiving lens is incident on the wavelength splitter 22. The visible light-near infrared light in the echo is reflected by the wavelength splitter 22, and the shortwave infrared light is transmitted through the wavelength splitter 22. In this way, the wavelength splitter 22 splits the echo into two beams, namely visible-near infrared echo and shortwave infrared echo. The visible-near infrared echo is incident on the first diffraction grating 23. The first diffraction grating has a response spectral segment of visible and near-infrared spectrums. The first diffraction grating 23 divides the visible-near infrared echo into optical bands arranged in accordance with wavelengths, and the optical bands are incident on the first photoelectric sensor 24. The first photoelectric sensor 24 converts the optical signal into an electrical signal and sends the electrical signal to the first digital collecting card 31. The first digital collecting card 31 digitally samples the electrical signal and sends the sampled signal to the computer 33. The shortwave infrared echo is incident on the second diffraction grating 25. The second diffraction grating has a response spectral segment of shortwave infrared spectrum. The second diffraction grating 25 divides the shortwave infrared echo into optical bands arranged in accordance with wavelengths, and the optical bands are incident on the second photoelectric sensor 26. The second photoelectric sensor 26 converts the optical signal into an electrical signal, and sends the electrical signal to the second digital collecting card 32. The second digital collecting card 32 digitally samples the electrical signal and sends the sampled signal to the computer 33.

The computer 33 performs analysis and processing based on the received sampled main wave signal, the sampled visible-near infrared echo signal and the sampled shortwave infrared echo signal, to obtain the three-dimensional information and the spectral information of the detection target.

The lidar system based on visible-near infrared-shortwave infrared light bands according to the first embodiment of the present disclosure uses the laser light source 11, which generates the supercontinuum spectrum laser including three bands of visible light, near-infrared light and shortwave infrared light, so as to enable convenient and efficient hyperspectral measurement of the visible light, near-infrared light, and shortwave infrared light without needing to replace the laser light source. The laser light source 11 emits laser of visible, near-infrared, and shortwave infrared light bands at the same time, thereby enabling convenient and efficient hyperspectral measurement of the visible light, near-infrared light, and shortwave infrared light to the detection target at the same time by the wavelength splitter 22 at the receiving end, and improving the capability of the lidar system detecting spectral information of the target and application range. Also, the lidar system only needs a lidar device when detecting a target, without a spectral imaging device; therefore, there is no alignment problem with respect to fields of view of the lidar device and the spectral imaging device at a high degree of matching. Also, the detection light reflected by the detection target and received by the lidar contains ranging information and spectral information of the same point on the target, and the two kinds of information is completely from the same reflected light on a measured point of the detection target. The ranging information is completely matched with the spectral information, and there is no fusion-matching problem between the ranging information and the spectral information in principle, so there is no need for the subsequent fusion-matching of the ranging data points with the spectral image data, and there is also no need for an interpolation and other operations in the fusion-matching process. Only a simple separation of the ranging information from the spectral information is needed, so more accurate measurement results and simpler post-processing algorithms can be provided.

In a second embodiment of the present disclosure, for the sake of conciseness, any technical feature described in the above first embodiment that may be used for the same application is incorporated herein, and the same description is omitted. In the lidar system based on visible-near infrared-shortwave infrared light bands, the wavelength splitter 22, the first diffraction grating 23, and the first photoelectric sensor 24 are sequentially disposed in front of the receiving lens, and the second diffraction grating 25 and the second photoelectric sensor 26 are sequentially disposed in a vertical direction of the optical axis and below the wavelength splitter. The signal input end of the first digital collecting card is connected to the signal output ends of the main wave photoelectric sensor and the second photoelectric sensor, and the signal input end of the second digital collecting card is connected to the signal output ends of the main wave photoelectric sensor and the first photoelectric sensor. The wavelength splitter 22 reflects the laser in shortwave infrared band with high reflectivity and transmits the laser in visible-near infrared bands with increased transmittance. In the lidar system according to the second embodiment of the present disclosure, the positions of the first diffraction grating 23, the first photoelectric sensor 24, and the positions of the second diffraction grating 25, the second photoelectric sensor 26 are interchanged, which can also achieve the objects of the present disclosure.

In a third embodiment of the present disclosure, for the sake of conciseness, any technical feature described in the above first and second embodiments that may be used for the same application is incorporated herein, and the same description is omitted. The computer stores the received sampled main wave signal, the sampled visible-near infrared echo signal and the sampled shortwave infrared echo signal, and sends them to an upper computer. The upper computer performs subsequent analysis and processing to obtain the three-dimensional information and the spectral information of the detection target.

It should be noted that, in the accompanying drawings or the context of the specification, implementations not shown or described are all known to those skilled in the art and therefore are not described in detail. In addition, the above-mentioned definition of each element is not limited to various specific structures and shapes mentioned in the embodiments, and those skilled in the art can simply modify or replace them, for example:

(1) The optical path element may also be replaced with other types of elements as long as the same function can be achieved;

(2) The description may provide examples of parameters that contain specific values, but these parameters need not be exactly equal to corresponding values, but may approximate to the corresponding values within acceptable error tolerances or design constraints;

(3) The directional terms mentioned in the embodiments, such as “above”, “below”, “front”, “behind”, “left”, “right”, etc., are only for reference to the drawings, and are not used to limit the scope of the present disclosure; and

(4) The above embodiments may be mixed and used with each other or with other embodiments based on considerations of design and reliability, that is, the technical features in different embodiments may be freely combined to form more embodiments.

In addition, the terms such as “visible light”, “near-infrared”, “shortwave infrared”, “hyperspectral measurement” and the like used in the present disclosure all have the same meanings as commonly understood by those skilled in the art, and are no longer described in detail herein.

As described above, the lidar system based on visible-near infrared-shortwave infrared light bands according to the present disclosure uses the laser light source, which emits supercontinuum spectrum laser including visible light, near-infrared light and shortwave infrared light, so as to enable convenient and efficient hyperspectral measurement of the visible light, near-infrared light, and shortwave infrared light without needing to replace the laser light source. The laser light source emits laser of visible, near-infrared, and shortwave infrared light bands at the same time, thereby enabling convenient and efficient hyperspectral measurement of the visible light, near-infrared light, and shortwave infrared light to the detection target at the same time by the wavelength splitter at the receiving end, and improving the capability of the lidar system detecting spectral information of the target and application range. Laser is detected and received using detectors with different response characteristics according to wave bands of the laser, so as to reduce an influence of a detector unable to simultaneously detect the visible-near infrared bands and the shortwave infrared band due to different response characteristics of the detector to different spectral bands, and thus the capability of the lidar system simultaneously detecting the visible-near infrared bands and the shortwave infrared band can be improved.

The above describes preferred embodiments of the present disclosure. It should be noted that the preferred embodiments are only for understanding the present disclosure and are not intended to limit the scope of the present disclosure. Moreover, the features in the preferred embodiments are applicable to both the method embodiments and the device embodiments, unless explicitly noted otherwise. The technical features appearing in the same or different embodiments can be used in combination without conflicting with each other.

It should be noted that the above-mentioned definition of each element is not limited to various specific structures or shapes mentioned in the embodiments, and those skilled in the art can simply replace them in a well-known way. The purposes, technical solutions and advantages of the present disclosure are further described in detail in the above-mentioned specific embodiments. It should be understood that the above description is only specific embodiments of the present disclosure and is not intended to limit the present disclosure. Any modification, equivalent replacement, and improvement made within the spirit and principle of the present disclosure should be included in the scope of the present disclosure.

1. A lidar system based on visible-near infrared-shortwave infrared light bands, comprising:
a light source sub-system configured to generate supercontinuum spectrum laser comprising three bands of visible light, near-infrared light and shortwave infrared light, wherein part of the supercontinuum spectrum laser is emitted as detection light to a detection target and forms an echo, and part of the supercontinuum spectrum laser is used as a main wave of the lidar and generates a main wave electrical signal;
a light receiving sub-system configured to receive an echo reflected by the detection target, divide the echo into a visible-near infrared echo and a shortwave infrared echo, and generate a visible-near infrared echo electrical signal and a shortwave infrared echo electrical signal; and
a signal collecting and processing sub-system configured to control the light source sub-system to emit the supercontinuum spectrum laser, and receive the visible-near infrared echo electrical signal, the shortwave infrared echo electrical signal and the main wave electrical signal, and perform analysis and processing to obtain three-dimensional information and spectral information of the detection target.

2. The lidar system of claim 1, wherein the light source sub-system comprises a laser light source, a beam collimator, a beam splitter, and a main wave photoelectric sensor;
wherein the laser light source emits the supercontinuum spectrum laser comprising the three bands of the visible light, the near-infrared light, and the shortwave infrared light;
the supercontinuum spectrum laser is incident on the beam splitter after being collimated by the beam collimator, part of the light is transmitted through the beam splitter and emitted as the detection light to the detection target, part of the light is reflected by the beam splitter, and the reflected light is received by the main wave photoelectric sensor as a main wave of the lidar, and the main wave photoelectric sensor generates the main wave electrical signal.

3. The lidar system of claim 2, wherein the light receiving sub-system comprises a receiving lens, a wavelength splitter, a first diffraction grating, a first photoelectric sensor, a second diffraction grating, and a second photoelectric sensor;
wherein an echo formed after the detection light is reflected by the detection target is received by the receiving lens, and an echo passing through the receiving lens is incident on the wavelength splitter, and the visible-near infrared echo is reflected by the wavelength splitter, the shortwave infrared echo is transmitted through the wavelength splitter;
the visible-near infrared echo is incident on the first diffraction grating, the first diffraction grating divides the visible-near infrared echo into optical bands arranged in accordance with wavelengths, the optical bands are incident on the first photoelectric sensor, and the first photoelectric sensor converts the visible-near infrared echo into the visible-near infrared echo electrical signal; and
the shortwave infrared echo is incident on the second diffraction grating, the second diffraction grating divides the shortwave infrared echo into optical bands arranged in accordance with wavelengths, the optical bands are incident on the second photoelectric sensor, and the second photoelectric sensor converts the shortwave infrared echo into the shortwave infrared echo electrical signal.

4. The lidar system of claim 3, wherein the signal collecting and processing sub-system comprises a first digital collecting card, a second digital collecting card, and a computer;
wherein a signal input end of the first digital collecting card is connected to signal output ends of the main wave photoelectric sensor and the first photoelectric sensor, and a signal input end of the second digital collecting card is connected to signal output ends of the main wave photoelectric sensor and the second photoelectric sensor, the signal output ends of the first digital collecting card and the second digital collecting card are connected to the computer, and a signal output end of the computer is connected to the laser light source.

5. The lidar system of claim 4, wherein the computer generates a trigger signal that controls the laser light source to emit the supercontinuum spectrum laser;
the first digital collecting card and the second digital collecting card receive the main wave electrical signal as a main wave trigger signal, perform digital sampling on the main wave trigger signal, and send the sampled main wave trigger signal to the computer;
the first digital collecting card digitally samples the visible-near infrared echo electrical signal and sends the sampled visible-near infrared echo signal to the computer;
the second digital collecting card digitally samples the shortwave infrared echo electrical signal and sends the sampled shortwave infrared echo signal to the computer; and
the computer performs analysis and processing based on the received sampled main wave trigger signal, the sampled visible-near infrared echo signal and the sampled shortwave infrared echo signal, to obtain the three-dimensional information and the spectral information of the detection target.

6. The lidar system of claim 2, wherein the light receiving sub-system comprises a receiving lens, a wavelength splitter, a first diffraction grating, a first photoelectric sensor, a second diffraction grating, and a second photoelectric sensor;
wherein an echo formed after the detection light is reflected by the detection target is received by the receiving lens, and an echo passing through the receiving lens is incident on the wavelength splitter, and the shortwave infrared echo is reflected by the wavelength splitter, the visible-near infrared echo is transmitted through the wavelength splitter;
the shortwave infrared echo is incident on the first diffraction grating, the first diffraction grating divides the shortwave infrared echo into optical bands arranged in accordance with wavelengths, the optical bands are incident on the first photoelectric sensor, and the first photoelectric sensor converts the shortwave infrared echo into the shortwave infrared echo electrical signal; and
the visible-near infrared echo is incident on the second diffraction grating, the second diffraction grating divides the visible-near infrared echo into optical bands arranged in accordance with wavelengths, the optical bands are incident on the second photoelectric sensor, and the second photoelectric sensor converts the visible-near infrared echo into the visible-near infrared echo electrical signal.

7. The lidar system of claim 6, wherein the signal collecting and processing sub-system comprises a first digital collecting card, a second digital collecting card, and a computer;
wherein a signal input end of the first digital collecting card is connected to signal output ends of the main wave photoelectric sensor and the first photoelectric sensor, and a signal input end of the second digital collecting card is connected to signal output ends of the main wave photoelectric sensor and the second photoelectric sensor, the signal output ends of the first digital collecting card and the second digital collecting card are connected to the computer, and a signal output end of the computer is connected to the laser light source.

8. The lidar system of claim 7, wherein the computer generates a trigger signal that controls the laser light source to emit the supercontinuum spectrum laser;
the first digital collecting card and the second digital collecting card receive the main wave electrical signal as a main wave trigger signal, perform digital sampling on the main wave trigger signal, and send the sampled main wave trigger signal to the computer;
the first digital collecting card digitally samples the shortwave infrared echo electrical signal and sends the sampled shortwave infrared echo signal to the computer;
the second digital collecting card digitally samples the visible-near infrared echo electrical signal and sends the sampled visible-near infrared echo signal to the computer; and
the computer performs analysis and processing based on the received sampled main wave trigger signal, the sampled visible-near infrared echo signal and the sampled shortwave infrared echo signal, to obtain the three-dimensional information and the spectral information of the detection target.

9. The lidar system of claim 3, wherein the computer is connected to an upper computer, and the computer stores the received sampled main wave trigger signal, the sampled visible-near infrared echo signal and the sampled shortwave infrared echo signal and sends them to the upper computer, and the upper computer performs subsequent analysis and processing to obtain the three-dimensional information and the spectral information of the detection target.

10. The lidar system of claim 3, wherein the wavelength splitter is a lens with increased transmittance and high reflectivity.
